(19) United States
(12) Patent Application Publication
(10) Pub. No.: US 2025/0105898 A1
(43) Pub. Date: Mar. 27, 2025

(54) MECHANISM FOR TESTING MODEL BASED PREDICTION ACCURACY

(71) Applicant: Nokia Technologies Oy, Espoo (FI)

(72) Inventors: Rachit MAHENDRA, Bangalore (IN); Bharath Ramesh KASHYAP, Bangalore (IN); Dimitri GOLD, Espoo (FI); Fahad SYED MUHAMMAD, Massy (FR)

(21) Appl. No.: 18/819,022

(22) Filed: Aug. 29, 2024

(30) Foreign Application Priority Data
Sep. 26, 2023 (IN) 202341064597

(51) Int. Cl. H04B 7/06; H04W 24/02

(52) U.S. Cl. CPC H04B 7/0626; H04W 24/02

(57) ABSTRACT

Embodiments of the present disclosure relate to a test framework to evaluate the CSI prediction accuracy for AI/ML based CSI prediction use case without the need for the DUT to send the ground truth to the test equipment separately. Further, embodiments of the present disclosure propose a procedure to obtain the parameter values predicted by the DUT and the corresponding ground truth at the TE side independently during the conformance testing.

### CROSS-REFERENCE TO RELATED APPLICATION

The present application claims priority to, and the benefit of, India Provisional Application No. 202341064597, filed Sep. 26, 2023, the contents of which are hereby incorporated by reference in their entirety.

### FIELD

Embodiments of the present disclosure generally relate to the field of telecommunication and in particular to devices, methods, apparatuses and computer readable storage media for testing model based prediction accuracy.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. By way of example, the AI/ML may be employed in predicting channel state information (CSI). Further, based on collection of various measurements and feedbacks from UEs and network nodes, historical data and the like, AI/ML model-based solutions and predicted CSI could improve system performance. Therefore, it is worth studying on determining a prediction accuracy of the AI/ML model.

### SUMMARY

In general, example embodiments of the present disclosure provide a solution for testing model based prediction accuracy.

In a first aspect of the present disclosure, there is provided a first device. The first device comprises at least one processor; and at least one memory storing instructions that, when executed by the at least one processor, cause the first device to: receive, from a second device, a plurality of measured values of channel state information, wherein each of the measured values is corresponding to one set of a plurality of sets of channel parameters, and each set of channel parameters corresponds to a condition of a channel between the first device and the second device; receive, from the second device, a plurality of predicted values of the channel state information that is predicted by a machine learning based model, wherein each of the predicted values is corresponding to one of the plurality of sets of channel parameters; and determine a prediction accuracy of the machine learning based model by comparing the plurality of measured values and the plurality of predicted values of the channel state information for each set of channel parameters.

In a second aspect of the present disclosure, there is provided a second device. The second device comprises at least one processor; and at least one memory storing instructions that, when executed by the at least one processor, cause the second device to: transmit, to a first device, a plurality of measured values of channel state information, wherein each of the measured values is corresponding to one set of a plurality of sets of channel parameters, and each set of channel parameters corresponds to a condition of a channel between the first device and the second device; and transmit, to a first device, a plurality of predicted values of the channel state information that is predicted by a machine learning based model, wherein each of the predicted values is corresponding to one of the plurality of sets of channel parameters.

In a third aspect of the present disclosure, there is provided a method. The method comprises: receiving, from a second device, a plurality of measured values of channel state information, wherein each of the measured values is corresponding to one set of a plurality of sets of channel parameters, and each set of channel parameters corresponds to a condition of a channel between the first device and the second device; receiving, from the second device, a plurality of predicted values of the channel state information that is predicted by a machine learning based model, wherein each of the predicted values is corresponding to one of the plurality of sets of channel parameters; and determining a prediction accuracy of the machine learning based model by comparing the plurality of measured values and the plurality of predicted values of the channel state information for each set of channel parameters.

In a fourth aspect of the present disclosure, there is provided a method. The method comprises: transmitting, to a first device, a plurality of measured values of channel state information, wherein each of the measured values is corresponding to one set of a plurality of sets of channel parameters, and each set of channel parameters corresponds to a condition of a channel between the first device and the second device; and transmitting, to a first device, a plurality of predicted values of the channel state information that is predicted by a machine learning based model, wherein each of the predicted values is corresponding to one of the plurality of sets of channel parameters.

In a fifth aspect of the present disclosure, there is provided a first apparatus. The first apparatus comprises means for receiving, from a second device, a plurality of measured values of channel state information, wherein each of the measured values is corresponding to one set of a plurality of sets of channel parameters, and each set of channel parameters corresponds to a condition of a channel between the first device and the second device; means for receiving, from the second device, a plurality of predicted values of the channel state information that is predicted by a machine learning based model, wherein each of the predicted values is corresponding to one of the plurality of sets of channel parameters; and means for determining a prediction accuracy of the machine learning based model by comparing the plurality of measured values and the plurality of predicted values of the channel state information for each set of channel parameters.

In a sixth aspect of the present disclosure, there is provided a second apparatus. The second apparatus comprises means for transmitting, to a first device, a plurality of measured values of channel state information, wherein each of the measured values is corresponding to one set of a plurality of sets of channel parameters, and each set of channel parameters corresponds to a condition of a channel between the first device and the second device; and means for transmitting, to a first device, a plurality of predicted values of the channel state information that is predicted by a machine learning based model, wherein each of the predicted values is corresponding to one of the plurality of sets of channel parameters.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 shows a concept of channel prediction, where the radio channel is observed over a period of time and measured by CSI reference signals (RSs) and predicted into the future;

FIG. 2 illustrates an example environment in which example embodiments of the present disclosure may be implemented;

FIG. 3A illustrates a block diagram of conducted mode conformance testing;

FIG. 3B illustrates a block diagram of over the air (OTA) mode conformance testing;

FIG. 4 shows a signaling chart illustrating a process of testing model based prediction accuracy according to some example embodiments of the present disclosure;

FIG. 5 shows a flowchart of an example method of testing model based prediction accuracy according to some example embodiments of the present disclosure;

FIG. 6 shows a flowchart of an example method of testing model based prediction accuracy according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station, a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The term “AI/ML model” used herein may refer to a data driven algorithm that applies AI/ML techniques to generate a set of outputs based on a set of inputs. The term “AI/ML model” may be used interchangeably with the term “model.” The term “Channel State Information (CSI)” used herein may refer to channel properties of a communication link. CSI describes how a signal propagate from the transmitter to the receiver and represents the combined effect of, for example, scattering, fading, and power decay with distance. The term “CSI report” may refer to a report that indicate how good or bad the channel is. The term “AI/ML feature” or “AI/ML functionality” used herein may refer to a feature or function that is implemented using the AI/ML model.

As mentioned above, AI/ML model may be applied in predicting CSI. AI/ML enabled CSI feedback enhancement is one of selected use-case for the studying. One of the selected sub use cases for CSI feedback enhancement is CSI Prediction. CSI prediction accuracy is one of the selected test metrics/key performance indictors (KPI) s for further study for performance evaluation of inference.

Getting accurate CSI is challenging due to rapid channel variation and multi-path fading. The inaccuracy of CSI imposes severe impact on the performance of a wide range of adaptive wireless systems. So, a channel prediction that can optimize the current CSI by forecasting the future CSI in advance with time, can help improve the accuracy of CSI. AI/ML based solutions can help predict the channel for future time.

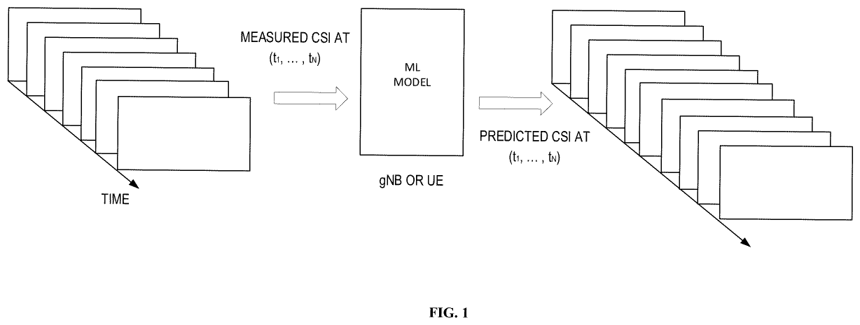

FIG. 1 illustrates a basic idea for channel prediction, where the radio channel is measured over several time instances, typically for frequency division duplex (FDD) systems based on regularly transmitted CSI reference signals (RSs). Then the UE or the gNB may input the estimated CSI, either directly or after some pre-processing, into the pre-trained ML model, which outputs the predicted CSI for one- or several-time steps.

Further, it will be useful to predict as CSI the explicit radio channel evolution in the time and/or the frequency domain as this will enable any type of precoding, will support any type of multi-user multi-input multi-output (MU-MIMO) user grouping and scheduling and therefore is the basis for more advanced future concepts like extensive massive MIMO, or cell free massive MIMO. Alternatively, the CSI prediction might be close to current Type II CSI reporting and predicting parameters like precoding matrix indicator (PMI), rank indicator (RI), channel quality indicator (CQI) and the like. Note that the possible inference and reporting options for channel prediction are closely related to the options as discussed above for channel compression.

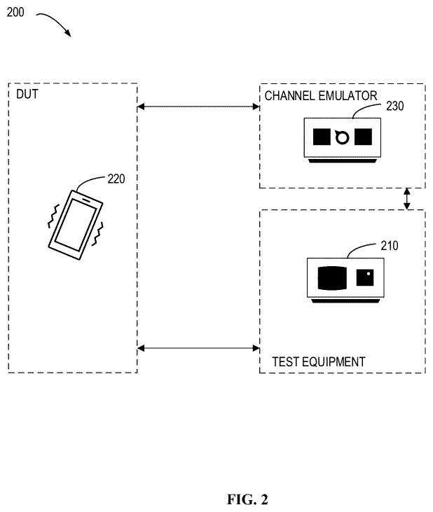

FIG. 2 illustrates an example communication environment 200 in which example embodiments of the present disclosure can be implemented. The communication environment 200 includes a first device 210, a second device 220 and a third device 230. The first device 210 may include a test equipment. By way of example, the first device 210 may be a network device. The second device 220 may include a device under test (DUT). For example, the second device 220 may be a UE. The second device 220 can interact with the first device 210. For example, the second device 220 may directly interact with the first device 210. Alternatively, or in addition, the second device 220 may interact with the first device 210 through the third device 230. In some other example embodiments, the second device 220 and the first device 210 may interact with each other directly and/or through the third device 230. The third device 230 may include a channel emulator which is used to simulate a communication condition. In some example embodiments, the third device 230 may be implemented with the first device 210.

In some example embodiments, if the second device 220 is a terminal device, and the first device 210 is a network device, a link from the first device 210 to the second device 220 is referred to as a downlink (DL), and a link from the second device 220 to the first device 210 is referred to as an uplink (UL). In DL, the first device 210 is a transmitting (TX) device (or a transmitter), and the second device 220 is a receiving (RX) device (or a receiver). In UL, the second device 220 is a TX device (or a transmitter), and the first device 210 is a RX device (or a receiver).

Communications in the communication environment 200 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The AI/ML model performance testing may be applied to the communication environment 200. The conformance testing can be performed in two modes/ways: conducted/conductive mode and over the air (OTA) mode.

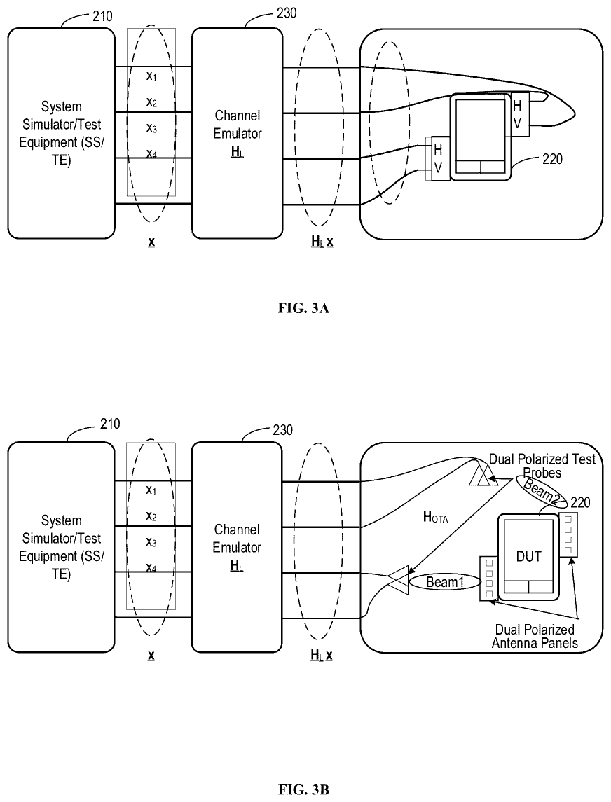

In conducted mode testing, each UE antenna port is connected to the test system via 50 Ohm coaxial cables. The conductive mode testing is only used for frequency range (FR1) test cases and the example illustration of such a test system is given in FIG. 3A where the third device 230 (i.e., channel emulator) is used to model a particular realization of the wireless fading channel in a controlled way for conformance testing purposes. The crosstalk generated by the wireless channel for a UE deployed in the field is, thus, modelled in the channel emulator H_{L} for the purpose of conformance testing.

For conducted test system, the received signal at the DUT in the DL can be modeled as:

$$y = {H}_{L} x , \qquad ( 1 )$$

where x represents the signal vector to be transmitted, H_{L} represents the simulated channel matrix, and y represents the signal vector received at the UE/DUT.

In OTA mode testing, the UE/DUT is placed inside of the anechoic (or test) chamber and the test system is connected to one or more probes installed at different positions (fixed or moving) inside of that chamber. The OTA mode testing is used in 3GPP framework for both FR1 as well as FR2 test cases and the example illustration of such a test system is given in FIG. 3B where the function of the third device 230 and the first device 210 are the same as that explained in Conducted mode testing, and test probes are installed inside the test chamber (e.g., anechoic chamber) to transmit/receive the signals to/from the DUT using the OTA wireless medium.

For OTA test system, the received signal at the DUT in the DL can be modeled as:

$$y = {H}_{OTA} {H}_{L} x , \qquad ( 2 )$$

where x represents the signal vector to be transmitted, H_{L} represents the simulated channel matrix, H_{OTA} comprises the OTA test chamber and UE (including spatial filters), and y represents the signal vector received at the UE/DUT.

As mentioned above, CSI prediction accuracy is one of the test metrics for CSI prediction use case which is currently under consideration for inference performance verification. Therefore, it is important to find a test procedure to obtain CSI prediction accuracy. One of the main challenges in such verification is the extraction of the ground truth.

The CSI prediction accuracy for AI/ML based CSI prediction use case can be potentially evaluated by comparing the predicted CSI values with the actual measurements performed by the DUT considered as the ground truth. DUT reports both (measured and predicted) CSI reports back to the test equipment where the comparison of the predicted values with the reported ground truth takes place to derive prediction accuracy. However, both functionalities (i.e., CSI measurements and prediction) may be active in this case simultaneously and this might not be supported by all devices.

As two CSI reports (one corresponds to ground truth and other for prediction) need to be sent to the network/TE, more signaling support is required. The DUT vendors might not be willing to share the ground truth related information with the test equipment. It is still not clear how to obtain the training data set, which is based on the ground truth and is required to train the AI/ML model for future prediction, before starting the AI/ML feature's actual conformance test. Therefore, a solution on testing model based prediction accuracy is needed.

According to embodiments of the present disclosure, it provides a test framework to evaluate the CSI prediction accuracy for AI/ML based CSI prediction use case without the need for the DUT to send the ground truth to the test equipment separately. Further, embodiments of the present disclosure propose a procedure to obtain the parameter values predicted by the DUT and the corresponding ground truth at the TE side independently during the conformance testing.

In some example embodiments, there may be 2 phases: Phase I (Ground Truth Collection) and Phase II (Evaluation by comparing the predicted output with ground truth).

During Phase I, the first device 210 may configure the second device 220 to use non-AI/ML based functionality and configure the channel parameters at the third device 230 to simulate a given channel condition. The output of the second device 220 may be stored at the first device 210 as ground truth that will be used in the next phase. In particular, during Phase I, the first device 210 may configure the test environment using at least the third device 230 and the test parameters for the second device 220. In addition, other conditions, such as, test probe locations, DUT (i.e., the second device 220) orientation, may also be configured by the first device 210. The third device 230 may emulate the channel condition as per configuration. Then the first device 210 may configure the second device 220 and start the measurement using a non-AI/ML functionality and send configured CSI RS as per channel configuration. The second device 220 may report the measurement output, which can be used as ground truth by the first device 210. The ground truth may be stored at the first device 210, which can also be used as a source of training set.

During Phase II, the first device 210 may configure the second device 220 to use the AI/ML based functionality and configure the channel parameters as configured in Phase I to extract the ground truth. The output of the second device 220 may be then compared with the ground truth from Phase I to evaluate the prediction accuracy of AI/ML enabled functionality. In particular, the first device 210 may configure the third device 230 with similar channel parameters that were configured in Phase I, which ensures that the same channel condition is available for the second device 220 as that was used for ground truth extraction. The first device 210 may configure the second device 220 to use the AI/ML based functionality, for example, configure the second device 220 to use AI/ML based CSI prediction. In this case, the second device 220 may use the AI/ML functionality and transmit the test output to the first device 210, for example, AI/ML based predicted CSI report. At this point, the first device 210 may have already obtain the ground truth collected for a set of channel condition and the predicted output from the AI/ML based functionality for the same set of channel conditions. Thus, the first device 210 may evaluate the prediction accuracy by comparing the predicted output with the collected ground truth.

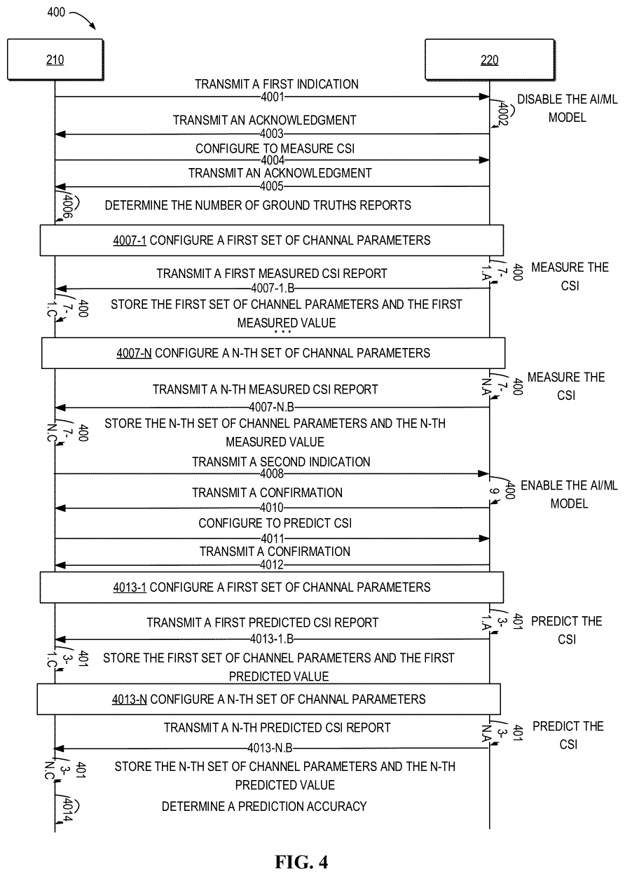

Example embodiments of the present disclosure will be described in detail below with reference to the accompanying drawings. Reference is now made to FIG. 4, which illustrates a signaling flow 400 for testing model based prediction accuracy according to some example embodiments of the present disclosure. For the purposes of discussion, the signaling flow 400 will be discussed with reference to FIG. 2, for example, by using the first device 210 and the second device 220.

The first device 210 may transmit (4001) a first indication, that disables a AI/ML feature at the second device 220, to the second device 220. In other words, the second device 220 may receive the first indication from the first device 210. In this way, it can ensure that the second device 220 is not operating under AI/ML mode. If the AI/ML mode is currently being active, the first device 210 can instruct the second device 220 to turn off using its AI/ML feature. In some example embodiments, the first indication may be transmitted in a radio resource control (RRC) message.

The second device 220 may disable (4002) the AI/ML feature. For example, disabling the AI/ML feature is only required if the AI/ML feature is currently active. On receiving the first indication from the first device, the second device 220 may turn off its AI/ML feature.

After the second device 220 disables the model, the second device 220 may transmit (4003) an acknowledgment to the first device 210, which confirms that the second device 220 turn off its AI/ML feature. The acknowledgement may be indicated from the second device 220 to the first device 210 through, for example, an RRC message.

After the first device 210 obtains the acknowledgment indicating the model is turned off at the second device 220, the first device 210 may configure (4004) the second device 220 to measure CSI using non-AI/ML based method. The first device 210 may also configure the second device 220 to send the measured CSI report to the first device 210. After receiving the configuration from the first device 210 to measure and report the CSI, the second device 220 may transmit (4005) an acknowledgement confirming the reception of the configuration for measuring and reporting the CSI.

The first device 210 may determine (4006) the number of ground truth CSI reports. For example, the first device 210 may determine N ground truth CSI reports required to construct the training set for future inference derivation purpose. By way of example, the first device 210 may decide that the second device 220 will measure and send the CSI for 1000 different combinations of channel realizations and/or environment conditions.

The first device 210 may start constructing the ground truth table (or list) for future inference derivation (e.g., CSI accuracy prediction). For example, the first device 210 may configure a plurality of sets of channel parameters. In this case, each set of channel parameters may correspond to a condition of a channel between the first device and the second device. The second device 220 may transmit a plurality of measured values of channel state information. Each of the measured values may be corresponding to one set of a plurality of sets of channel parameters. In some example embodiments, the set of channel parameters may include one or more of: a channel realization for the second device 220, an orientation of the second device 220, a position of a test probe for the second device 220, or a power level of the test probe. A measured value of channel state information may include one or more of: channel quality indicator (CQI), precoding matrix indicator (PMI), CSI-RS resource indicator (CRI), synchronization signal physical broadcast channel (SS/PBCH) block resource indicator (SSBRI), layer indicator (LI), rank indicator (RI), layer 1 reference signal received power (L1-RSRP), layer 1 signal to interference plus noise ratio (L1-SINR) or Capability Index.

By way of example, in order to construct the ground truth table, the first device 210 may configure (4007-1) a first set of channel parameters (may also referred to as “the first set of features”). For example, the first device 210 may configure the first set of features, for example, by setting the third device 230 to produce a particular realization of the channel, and/or by setting the second device 220 in a particular orientation during the test (only for OTA testing), and/or setting the test chamber configuration by selecting the position(s) of test probe(s) and setting their power levels (only for OTA testing). In some example embodiments, the first device 210 may transmit a set of CSI RSs to the second device 220.

The second device 220 may measure (4007-1.A) the CSI corresponding to the first set of channel parameters. For example, the second device 220 may measure CQI corresponding to the first set of channel parameters. The second device 220 may generate a first measured CSI report that includes the first measured value of CSI.

The second device 220 may transmit (4007-1.B) the first measured CSI report to the first device 210. In other words, the first device 210 may receive the first measured CSI report from the second device 220. The first device 210 may store (4007-1.C) the first set of channel parameters and the first measured value of CSI in a ground truth table or list. The operations of 4007-1, 4007-1.A, 4007-1.B and 4007-1.C may be repeated for N times, if N ground truth CSI reports are needed.

As shown in FIG. 4, the first device 210 may configure (4007-N) the N-th set of channel parameters (may also referred to as “the N-th set of features”). The second device 220 may measure (4007-N.A) the CSI corresponding to the N-th set of channel parameters. For example, the second device 220 may measure CQI corresponding to the N-th set of channel parameters. The second device 220 may generate a N-th measured CSI report that includes the N-th measured value of CSI.

The second device 220 may transmit (4007-N.B) the N-th measured CSI report to the first device 210. In other words, the first device 210 may receive the N-th measured CSI report from the second device 220. The first device 210 may store (4007-1.C) the N-th set of channel parameters and the N-th measured value of CSI in the ground truth table or list. Table 1 below shows an example of the ground truth table. It is noted that Table 1 is only an example not limitation.

TABLE 1

| | | | | |
|---|---|---|---|---|
| | Feature 1 (e.g., | | | |
| | Channel | | Feature X (e.g., | Target |
| Configuration# | realization) | . . . | DUT orientation) | Value |

| | | | |
|---|---|---|---|
| 1 | Realization 1 | Orientation 5 | T1 |
| 2 | Realization 2 | Orientation 1 | T2 |
| . . . | . . . | . . . | . . . |
| N | Realization ‘R’ | Orientation ‘O’ | T_N |

For example, as shown in Table 1, the first set of channel parameters (i.e., Configuration #1) may include a set of features, such as, a feature “Channel realization” being Realization 1, and a feature “DUT orientation” being Orientation 5. The first measured value of CSI corresponding to the first set of channel parameter may be represented as T1 in the above table.

The first device 210 may transmit (4008) a second indication, that enables the model at the second device 220, to the second device 220. In other words, the second device 220 may receive the second indication from the first device 210. For example, after the ground truth table has been completely constructed, the first device 210 may instruct the second device 220 to turn on its AI/ML feature. The second indication can be indicated from the first device 210 to the second device 220 through, for example, an RRC message.

The second device 220 may enable (4009) the AI/ML feature. On receiving the second indication from the first device, the second device 220 may turn on its AI/ML feature.

After the second device 220 enables the AI/ML feature, the second device 220 may transmit (4010) an acknowledgment to the first device 210, which confirms that the second device 220 turn on its AI/ML feature. The acknowledgement may be indicated from the second device 220 to the first device 210 through, for example, an RRC message.

After the first device 210 obtains the acknowledgment indicating the model is turned on at the second device 220, the first device 210 may configure (4011) the second device 220 to measure CSI using an AI/ML based method. The first device 210 may also configure the second device 220 to send the predicted CSI report to the first device 210. After receiving the configuration from the first device 210 to predict the CSI, the second device 220 may transmit (4012) an acknowledgement confirming the reception of the configuration for predicting the CSI.

The first device 210 may start constructing the prediction table (list) for future inference derivation (e.g., CSI accuracy prediction). By way of example, the first device 210 may configure the plurality of sets of channel parameters, for example, in a random manner. The second device 220 may transmit a plurality of predicted values of channel state information. Each of the predicted values may be corresponding to one set of a plurality of sets of channel parameters.

By way of example, in order to construct the prediction table, the first device 210 may configure (4013-1) any one set of channel parameters (any one set of features) from the plurality of sets of channel parameters defined during the ground truth acquisition. Only as an example, the N-th set of channel parameters for the ground truth table may be used as the first set of channel parameters for the prediction table.

The second device 220 may predict (4013-1.A) the CSI corresponding to the N-th set of channel parameters. For example, the second device 220 may predict CQI corresponding to the N-th set of channel parameters. The second device 220 may generate a first predicted CSI report that includes the first predicted value of CSI corresponding to the N-th set of channel parameters.

The second device 220 may transmit (4013-1.B) the first predicted CSI report to the first device 210. In other words, the first device 210 may receive the first predicted CSI report from the second device 220. The first device 210 may store (4013-1.C) the N-th set of channel parameters and the first predicted value of CSI in a prediction table or list. The operations of 4013-1, 4013-1.A, 4013-1.B and 403-1.C may be repeated for N times, if N ground truth CSI reports are needed.

As shown in FIG. 4, the first device 210 may configure (4013-N) the first set of channel parameters (may also referred to as “the first set of features”). The second device 220 may predict (4013-N.A) the CSI corresponding to the first set of channel parameters. For example, the second device 220 may predict CQI corresponding to the first set of channel parameters. The second device 220 may generate a N-th predicted CSI report that includes the N-th predicted value of CSI corresponding to the first set of channel parameters.

The second device 220 may transmit (4013-N.B) the N-th predicted CSI report to the first device 210. In other words, the first device 210 may receive the N-th predicted CSI report from the second device 220. The first device 210 may store (4013-1.C) the first set of channel parameters and the N-th predicted value of CSI in the prediction table or list. Table 2 below shows an example of the prediction table. It is noted that Table 2 is only an example not limitation.

TABLE 2

| | | | | |
|---|---|---|---|---|
| | Feature 1 (e.g., | | Feature X | |
| | Channel | | (e.g., DUT | |
| Configuration# | realization) | . . . | orientation) | Predicted Value |

| | | | |
|---|---|---|---|
| N | Realization ‘R’ | Orientation | P_N |
| | | ‘O’ | |
| 2 | Realization 2 | Orientation 1 | P2 |
| . . . | . . . | . . . | . . . |
| 1 | Realization 1 | Orientation 5 | P1 |

For example, as shown in Table 2, the N-th set of channel parameters (i.e., Configuration #N) may include a set of features, such as, a feature “Channel realization” being Realization ‘R’, and a feature “DUT orientation” being Orientation ‘O’. The corresponding predicted value of CSI may be represented as P_N in the above table.

The first device 210 determines (4014) a prediction accuracy of the model by comparing the plurality of measured values and the plurality of predicted values of the channel state information. For example, the first device 210 may compare the ground truth table and the prediction table and evaluate the prediction accuracy to decide the test verdict. For example, for CSI prediction use cases, the first device 210 may check whether a cosine similarity between the plurality of measured values and the plurality of predicted values is within certain limits or not. Alternatively, the first device 210 can also adopt some other metric, e.g., checking whether the absolute/average/max. difference between P_i and T_i in each pair (P1, T1) . . . (P_N, T_N) is below some threshold ‘X’ or not.

In some example embodiments, if the determined prediction accuracy of the model is above or equal to an accuracy threshold, the model can still be used for a time duration. Alternatively, if the determined prediction accuracy of the model is below or equal to an accuracy threshold, the model may need to be updated.

According to embodiments of the present disclosure, it proposes a procedure to acquire the ground truth and prediction values over a non-overlapping timescale. In this way, it can avoid the device reporting fake prediction as the ground truth is not available at the device at the prediction time. Further, it may or may not need new signaling support.

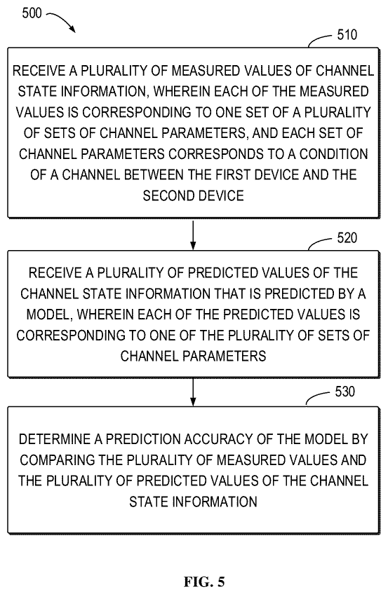

FIG. 5 shows a flowchart of an example method 500 implemented at a first device in accordance with some example embodiments of the present disclosure. For the purpose of discussion, the method 500 will be described from the perspective of the first device 210 in FIG. 2.

At block 510, the first device receives, from a second device, a plurality of measured values of channel state information. Each of the measured values is corresponding to one set of a plurality of sets of channel parameters. Each set of channel parameters corresponds to a condition of a channel between the first device and the second device.

At block 520, the first device receives, from the second device, a plurality of predicted values of the channel state information that is predicted by a machine learning based model. Each of the predicted values is corresponding to one of the plurality of sets of channel parameters.

At block 530, the first device determines a prediction accuracy of the machine learning based model by comparing the plurality of measured values and the plurality of predicted values of the channel state information for each set of channel parameters.

In some example embodiments, each set of channel parameters comprises at least one of: a particular realization of channel between the first and second device, an explicit orientation of the second device, an explicit position of at least one test probe, or an explicit power level of the at least one test probe or the test equipment.

In some example embodiments, the method 500 further comprises: determining the number of ground truth channel state information reports, wherein the ground truth channel state information is obtained through an actual channel state information measurement; and determining the plurality of sets of channel parameters, wherein the number of sets in the plurality of sets of channel parameters corresponds to the number of ground truth channel state information report.

In some example embodiments, the method 500 further comprises: transmitting, to the second device, a first indication to disable a machine learning model based prediction, before the reception of the plurality of measured values.

In some example embodiments, the method 500 further comprises: performing the following for a number of rounds, until the number of rounds equals to the number of ground truth channel state information reports: configuring a set of channel parameters from the plurality of sets of channel parameters; receiving, from the second device, a measured value of channel state information that is corresponding to the set of channel parameters; and storing the set of channel parameters and the measured value in a ground truth table.

In some example embodiments, the method 500 further comprises: transmitting, to the second device, a second indication to enable a machine learning model based prediction, before the reception of the plurality of predicted values.

In some example embodiments, the method 500 further comprises: performing the following for a number of rounds, until the number of rounds equals to the number of ground truth channel state information reports: configuring at set of channel parameters from the plurality of sets of channel parameters; receiving, from the second device, a predicted value of channel state information that is corresponding to the set of channel parameters; and storing the set of channel parameters and the predicted value in a prediction table.

In some example embodiments, the method 500 further comprises: determining prediction accuracy of the machine learning model based on a number of comparisons, wherein each comparison is between the measured value and the predicted value corresponding to the same set of channel parameters.

In some example embodiments, each measured value of the channel state information comprises at least one of: a measured channel quality indicator, CQI, a measured precoding matrix indicator, PMI, a measured channel state information reference signal, CSI-RS, a resource indicator, CRI, a measured synchronization signal/physical broadcast channel, SS/PBCH, a blocking resource indicator, SSBRI, a measured layer indicator, LI, a measured rank indicator, RI, a measured layer 1 reference signal received power, L1-RSRP, a measured layer 1 signal to interference plus noise ratio, L1-SINR, or a measured capability index.

In some example embodiments, each predicted value of the channel state information comprises at least one of: a predicted channel quality indicator, CQI, a predicted precoding matrix indicator, PMI, a predicted channel state information reference signal, CSI-RS, a resource indicator, CRI, a predicted synchronization signal/physical broadcast channel, SS/PBCH, blocking resource indicator, SSBRI, a predicted layer indicator, LI, a predicted rank indicator, RI, a predicted layer 1 reference signal received power, L1-RSRP, a predicted layer 1 signal to interference plus noise ratio, L1-SINR, or a predicted capability index.

In some example embodiments, the first device is one of: a test equipment, a system simulator, or a network device, and the second device is a device under test.

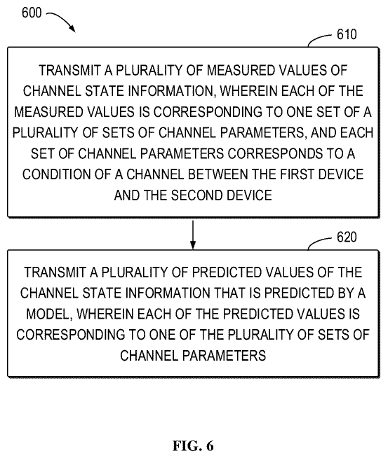

FIG. 6 shows a flowchart of an example method 600 implemented at a second device in accordance with some example embodiments of the present disclosure. For the purpose of discussion, the method 600 will be described from the perspective of the second device 220 in FIG. 2.

At block 610, the second device transmits, to a first device, a plurality of measured values of channel state information, wherein each of the measured values is corresponding to one set of a plurality of sets of channel parameters, and each set of channel parameters corresponds to a condition of a channel between the first device and the second device.

At block 620, the second device transmits, to a first device, a plurality of predicted values of the channel state information that is predicted by a machine learning based model, wherein each of the predicted values is corresponding to one of the plurality of sets of channel parameters.

In some example embodiments, each set of channel parameters comprises at least one of: a particular realization of channel between the first and second device, an explicit orientation of the second device, an explicit position of at least one test probe, or an explicit power level of the at least one test probe or the test equipment.

In some example embodiments, the method 600 further comprises: receiving, from the first device, a first indication to disable a machine learning model based prediction, before the reception of the plurality of measured values.

In some example embodiments, the method 600 further comprises: performing the following for a number of rounds, until the number of rounds equals to a predetermined number: measuring a value of channel state information corresponding to a set of channel parameters from the plurality of sets of channel parameters; and transmitting, to the first device, the measured value of channel state information.

In some example embodiments, the method 600 further comprises: receiving, from the first device, a second indication to enable a machine learning model based prediction, before the reception of the plurality of predicted values.

In some example embodiments, the method 600 further comprises: performing the following for a number of rounds, until the number of rounds equals to a predetermined number: predicting, by machine learning the model, a value of channel state information corresponding to a set of channel parameters from the plurality of sets of channel parameters; and transmitting, to the first device, the predicted value of channel state information.

In some example embodiments, each measured value of the channel state information comprises at least one of: a measured channel quality indicator, CQI, a measured precoding matrix indicator, PMI, a measured channel state information reference signal, CSI-RS, a resource indicator, CRI, a measured synchronization signal/physical broadcast channel, SS/PBCH, a blocking resource indicator, SSBRI, a measured layer indicator, LI, a measured rank indicator, RI, a measured layer 1 reference signal received power, L1-RSRP, a measured layer 1 signal to interference plus noise ratio, L1-SINR, or a measured capability index.

In some example embodiments, each predicted value of the channel state information comprises at least one of: a predicted channel quality indicator, CQI, a predicted precoding matrix indicator, PMI, a predicted channel state information reference signal, CSI-RS, a resource indicator, CRI, a predicted synchronization signal/physical broadcast channel, SS/PBCH, a blocking resource indicator, SSBRI, a predicted layer indicator, LI, a predicted rank indicator, RI, a predicted layer 1 reference signal received power, L1-RSRP, a predicted layer 1 signal to interference plus noise ratio, L1-SINR, or a predicted capability index.

In some example embodiments, the first device is one of: a test equipment, a system simulator, or a network device and the second device is a device under test.

In some example embodiments, a first apparatus capable of performing any of the method 500 (for example, the first device 210 in FIG. 2) may comprise means for performing the respective operations of the method 500. The means may be implemented in any suitable form. For example, the means may be implemented in a circuitry or software module. The first apparatus may be implemented as or included in the first device 210 in FIG. 2.

In some example embodiments, the first apparatus comprises means for receiving, from a second device, a plurality of measured values of channel state information, wherein each of the measured values is corresponding to one set of a plurality of sets of channel parameters, and each set of channel parameters corresponds to a condition of a channel between the first device and the second device; means for receiving, from the second device, a plurality of predicted values of the channel state information that is predicted by a machine learning based model, wherein each of the predicted values is corresponding to one of the plurality of sets of channel parameters; and means for determining a prediction accuracy of the machine learning based model by comparing the plurality of measured values and the plurality of predicted values of the channel state information for each set of channel parameters.

In some example embodiments, each set of channel parameters comprises at least one of: a particular realization of channel between the first and second device, an explicit orientation of the second device, an explicit position of at least one test probe, or an explicit power level of the at least one test probe or the test equipment.

In some example embodiments, the first apparatus further comprises: means for determining the number of ground truth channel state information reports, wherein the ground truth channel state information is obtained through an actual channel state information measurement; and means for determining the plurality of sets of channel parameters, wherein the number of sets in the plurality of sets of channel parameters corresponds to the number of ground truth channel state information report.

In some example embodiments, the first apparatus further comprises: means for transmitting, to the second device, a first indication to disable a machine learning model based prediction, before the reception of the plurality of measured values.

In some example embodiments, the first apparatus further comprises: means for performing the following for a number of rounds, until the number of rounds equals to the number of ground truth channel state information reports: configuring a set of channel parameters from the plurality of sets of channel parameters; receiving, from the second device, a measured value of channel state information that is corresponding to the set of channel parameters; and storing the set of channel parameters and the measured value in a ground truth table.

In some example embodiments, the first apparatus further comprises: means for transmitting, to the second device, a second indication to enable a machine learning model based prediction, before the reception of the plurality of predicted values.

In some example embodiments, the first apparatus further comprises: means for performing the following for a number of rounds, until the number of rounds equals to the number of ground truth channel state information reports: configuring at set of channel parameters from the plurality of sets of channel parameters; receiving, from the second device, a predicted value of channel state information that is corresponding to the set of channel parameters; and storing the set of channel parameters and the predicted value in a prediction table.

In some example embodiments, the first apparatus further comprises: means for determining prediction accuracy of the machine learning model based on a number of comparisons, wherein each comparison is between the measured value and the predicted value corresponding to the same set of channel parameters.

In some example embodiments, each measured value of the channel state information comprises at least one of: a measured channel quality indicator, CQI, a measured precoding matrix indicator, PMI, means for a measured channel state information reference signal, CSI-RS, a resource indicator, CRI, means for a measured synchronization signal/physical broadcast channel, SS/PBCH, blocking resource indicator, SSBRI, a measured layer indicator, LI, a measured rank indicator, RI, a measured layer 1 reference signal received power, L1-RSRP, a measured layer 1 signal to interference plus noise ratio, L1-SINR, or a measured capability index.

In some example embodiments, each predicted value of the channel state information comprises at least one of: a predicted channel quality indicator, CQI, a predicted precoding matrix indicator, PMI, means for a predicted channel state information reference signal, CSI-RS, a resource indicator, CRI, means for a predicted synchronization signal/physical broadcast channel, SS/PBCH, blocking resource indicator, SSBRI, a predicted layer indicator, LI, a predicted rank indicator, RI, a predicted layer 1 reference signal received power, L1-RSRP, a predicted layer 1 signal to interference plus noise ratio, L1-SINR, or a predicted capability index.

In some example embodiments, the first device is one of: a test equipment, a system simulator, or a network device, and the second device is a device under test.

In some example embodiments, the first apparatus further comprises means for performing other operations in some example embodiments of the method 500 or the first device 210. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second device 220 in FIG. 2) may comprise means for performing the respective operations of the method 600. The means may be implemented in any suitable form. For example, the means may be implemented in a circuitry or software module. The second apparatus may be implemented as or included in the second device 220 in FIG. 2.

In some example embodiments, the second apparatus comprises means for transmitting, to a first device, a plurality of measured values of channel state information, wherein each of the measured values is corresponding to one set of a plurality of sets of channel parameters, and each set of channel parameters corresponds to a condition of a channel between the first device and the second device; and means for transmitting, to a first device, a plurality of predicted values of the channel state information that is predicted by a machine learning based model, wherein each of the predicted values is corresponding to one of the plurality of sets of channel parameters.

In some example embodiments, each set of channel parameters comprises at least one of: a particular realization of channel between the first and second device, an explicit orientation of the second device, an explicit position of at least one test probe, or an explicit power level of the at least one test probe or the test equipment.

In some example embodiments, the second apparatus further comprises: means for receiving, from the first device, a first indication to disable a machine learning model based prediction, before the reception of the plurality of measured values.

In some example embodiments, the second apparatus further comprises: means for performing the following for a number of rounds, until the number of rounds equals to a predetermined number: measuring a value of channel state information corresponding to a set of channel parameters from the plurality of sets of channel parameters; and transmitting, to the first device, the measured value of channel state information.

In some example embodiments, the second apparatus further comprises: means for receiving, from the first device, a second indication to enable a machine learning model based prediction, before the reception of the plurality of predicted values.

In some example embodiments, the second apparatus further comprises: means for performing the following for a number of rounds, until the number of rounds equals to a predetermined number: predicting, by machine learning the model, a value of channel state information corresponding to a set of channel parameters from the plurality of sets of channel parameters; and means for transmitting, to the first device, the predicted value of channel state information.

In some example embodiments, each measured value of the channel state information comprises at least one of: a measured channel quality indicator, CQI, a measured precoding matrix indicator, PMI, means for a measured channel state information reference signal, CSI-RS, a resource indicator, CRI, means for a measured synchronization signal/physical broadcast channel, SS/PBCH, blocking resource indicator, SSBRI, a measured layer indicator, LI, a measured rank indicator, RI, a measured layer 1 reference signal received power, L1-RSRP, a measured layer 1 signal to interference plus noise ratio, L1-SINR, or a measured capability index.

In some example embodiments, each predicted value of the channel state information comprises at least one of: a predicted channel quality indicator, CQI, a predicted precoding matrix indicator, PMI, means for a predicted channel state information reference signal, CSI-RS, a resource indicator, CRI, means for a predicted synchronization signal/physical broadcast channel, SS/PBCH, blocking resource indicator, SSBRI, a predicted layer indicator, LI, a predicted rank indicator, RI, a predicted layer 1 reference signal received power, L1-RSRP, a predicted layer 1 signal to interference plus noise ratio, L1-SINR, or a predicted capability index.

In some example embodiments, the first device is one of: a test equipment, a system simulator, or a network device and the second device is a device under test.

In some example embodiments, the second apparatus further comprises means for performing other operations in some example embodiments of the method 600 or the second device 220. In some example embodiments, the means comprises at least one processor; and at least one memory storing instructions that, when executed by the at least one processor, cause the performance of the second apparatus.

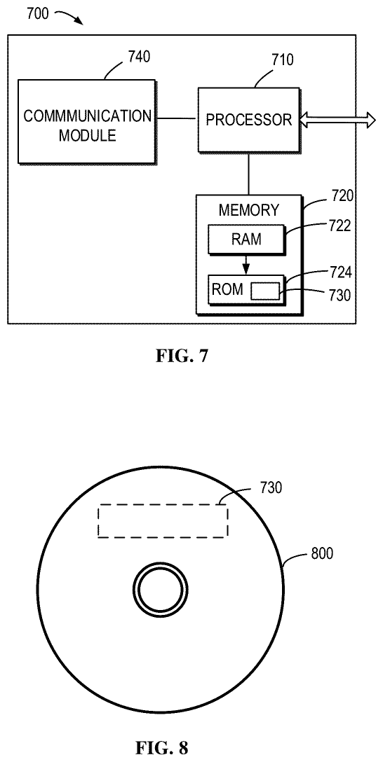

FIG. 7 is a simplified block diagram of a device 700 that is suitable for implementing example embodiments of the present disclosure. The device 700 may be provided to implement a communication device, for example, the first device 210 or the second device 220 as shown in FIG. 2. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first device, comprising:
at least one processor; and
at least one memory storing instructions that, when executed by the at least one processor, cause the first device to:
receive, from a second device, a plurality of measured values of channel state information, wherein each of the measured values is corresponding to one set of a plurality of sets of channel parameters, and each set of channel parameters corresponds to a condition of a channel between the first device and the second device;
receive, from the second device, a plurality of predicted values of the channel state information that is predicted by a machine learning based model, wherein each of the predicted values is corresponding to one of the plurality of sets of channel parameters; and
determine a prediction accuracy of the machine learning based model by comparing the plurality of measured values and the plurality of predicted values of the channel state information for each set of channel parameters.

2. The first device of claim 1, wherein each set of channel parameters comprises at least one of:
a particular realization of channel between the first and second device,
an explicit orientation of the second device,
an explicit position of at least one test probe, or
an explicit power level of the at least one test probe or the test equipment.

3. The first device of claim 1, wherein the first device is caused to:
determine the number of ground truth channel state information reports, wherein the ground truth channel state information is obtained through an actual channel state information measurement; and
determine the plurality of sets of channel parameters, wherein the number of sets in the plurality of sets of channel parameters corresponds to the number of ground truth channel state information report.

4. The first device of claim 1, wherein the first device is caused to:
transmit, to the second device, a first indication to disable a machine learning model based prediction, before the reception of the plurality of measured values.

5. The first device of claim 1, wherein the first device is caused to:
perform the following for a number of rounds, until the number of rounds equals to the number of ground truth channel state information reports:
configure a set of channel parameters from the plurality of sets of channel parameters;
receive, from the second device, a measured value of channel state information that is corresponding to the set of channel parameters; and
store the set of channel parameters and the measured value in a ground truth table.

6. The first device of claim 1, wherein the first device is caused to:
transmit, to the second device, a second indication to enable a machine learning model based prediction, before the reception of the plurality of predicted values.

7. The first device of claim 1, wherein the first device is caused to:
perform the following for a number of rounds, until the number of rounds equals to the number of ground truth channel state information reports:
configure at set of channel parameters from the plurality of sets of channel parameters;
receive, from the second device, a predicted value of channel state information that is corresponding to the set of channel parameters; and
store the set of channel parameters and the predicted value in a prediction table.

8. The first device of claim 7, wherein the first device is caused to:
determine prediction accuracy of the machine learning model based on a number of comparisons, wherein each comparison is between the measured value and the predicted value corresponding to the same set of channel parameters.

9. The first device of claim 1, wherein each measured value of the channel state information comprises at least one of:
a measured channel quality indicator,
a measured precoding matrix indicator,
a measured channel state information reference signal resource indicator,
a measured synchronization signal/physical broadcast channel block resource indicator,
a measured layer indicator,
a measured rank indicator,
a measured layer 1 reference signal received power,
a measured layer 1 signal to interference plus noise ratio, or
a measured capability index.

10. The first device of claim 1, wherein each predicted value of the channel state information comprises at least one of:
a predicted channel quality indicator,
a predicted precoding matrix indicator,
a predicted channel state information reference signal, resource indicator,
a predicted synchronization signal/physical broadcast channel, block resource indicator,
a predicted layer indicator,
a predicted rank indicator,
a predicted layer 1 reference signal received power,
a predicted layer 1 signal to interference plus noise ratio, or
a predicted capability index.

11. The first device of claim 1, wherein the first device is one of: a test equipment, a system simulator, or a network device, and the second device is a device under test.

12. A second device, comprising:
at least one processor; and
at least one memory storing instructions that, when executed by the at least one processor, cause the second device to:
transmit, to a first device, a plurality of measured values of channel state information, wherein each of the measured values is corresponding to one set of a plurality of sets of channel parameters, and each set of channel parameters corresponds to a condition of a channel between the first device and the second device; and
transmit, to a first device, a plurality of predicted values of the channel state information that is predicted by a machine learning based model, wherein each of the predicted values is corresponding to one of the plurality of sets of channel parameters.

13. The second device of claim 12, wherein each set of channel parameters comprises at least one of:
a particular realization of channel between the first and second device,
an explicit orientation of the second device,
an explicit position of at least one test probe, or
an explicit power level of the at least one test probe or the test equipment.

14. The second device of claim 12, wherein the second device is caused to:
receive, from the first device, a first indication to disable a machine learning model based prediction, before the reception of the plurality of measured values.

15. The second device of claim 12, wherein the second device is caused to:
perform the following for a number of rounds, until the number of rounds equals to a predetermined number:
measure a value of channel state information corresponding to a set of channel parameters from the plurality of sets of channel parameters; and
transmit, to the first device, the measured value of channel state information.

16. The second device of claim 12, wherein the second device is caused to:
receive, from the first device, a second indication to enable a machine learning model based prediction, before the reception of the plurality of predicted values.

17. The second device of claim 12, wherein the second device is caused to:
perform the following for a number of rounds, until the number of rounds equals to a predetermined number:
predict, by machine learning the model, a value of channel state information corresponding to a set of channel parameters from the plurality of sets of channel parameters; and
transmit, to the first device, the predicted value of channel state information.

18. The second device of claim 12, wherein each measured value of the channel state information comprises at least one of:
a measured channel quality indicator,
a measured precoding matrix indicator,
a measured channel state information reference signal, resource indicator, CRI,
a measured synchronization signal/physical broadcast channel, block resource indicator,
a measured layer indicator,
a measured rank indicator,
a measured layer 1 reference signal received power,
a measured layer 1 signal to interference plus noise ratio, or
a measured capability index.

19. The second device of claim 12, wherein each predicted value of the channel state information comprises at least one of:
a predicted channel quality indicator,
a predicted precoding matrix indicator,
a predicted channel state information reference signal, resource indicator, CRI,
a predicted synchronization signal/physical broadcast channel, block resource indicator,
a predicted layer indicator,
a predicted rank indicator,
a predicted layer 1 reference signal received power,
a predicted layer 1 signal to interference plus noise ratio, or
a predicted capability index.

20. A method, comprising:
transmitting, at a second device and to a first device, a plurality of measured values of channel state information, wherein each of the measured values is corresponding to one set of a plurality of sets of channel parameters, and each set of channel parameters corresponds to a condition of a channel between the first device and the second device; and
transmitting, to a first device, a plurality of predicted values of the channel state information that is predicted by a machine learning based model, wherein each of the predicted values is corresponding to one of the plurality of sets of channel parameters.
